(19) United States
(12) Patent Application Publication
(10) Pub. No.: US 2021/0129046 A1
(43) Pub. Date: May 6, 2021

(54) Apparatus and Associated Methods for Cleaning Slug Catcher

(71) Applicant: WeldFit Corporation, Houston, TX (US)

(72) Inventor: Adam Scott MURRAY, Allen, TX (US)

(21) Appl. No.: 16/669,292

(22) Filed: Oct. 30, 2019

(51) Int. Cl. B01D 19/00; F17D 3/01; F17D 1/00

(52) U.S. Cl. CPC B01D 19/0052; B01D 19/0063; F17D 1/005; F17D 3/01

(57) ABSTRACT

A cleaning apparatus is used with a slug catcher for a pipeline upstream of a process. An inlet of the catcher separates liquid and gas of the flow, and a gas outlet outputs the gas. Tubes of the catcher extend below the inlet to collect the liquid in a liquid outlet for output to the process. An actuator of the apparatus has a mover disposed internal to a portion of the liquid outlet. Movable with the actuator, the mover moves any debris relative to at least one outlet port of the liquid outlet. For example, a motor can rotate a feed screw in a sludge manifold to move a paddle for scrubbing debris to an outlet in the manifold. In another example, a motor can rotate an auger in the sludge manifold to move debris to the manifold's outlet. The apparatus can be manually or automatically operated.

### BACKGROUND OF THE DISCLOSURE

A gas pipeline uses a slug catcher at a receiving terminal to handle slugs of liquid that may form in multi-phase flow of the pipeline. The slugs can form due to any number of reasons, such as elevation changes the pipeline, the flow of gas in the pipeline, and the like. Slugs may also be formed intentionally during pigging operations.

When slugs are formed, gas may be moved in the pipeline as large, bullet-shaped bubbles with a diameter close to the pipe's diameter. The gas bubbles may be separated by slugs of continuous liquid that bridge the pipe and usually contain small gas bubbles. Liquid may also form a thin film between the gas bubbles and the pipe wall. The slug catcher is disposed between the upstream pipeline and downstream processing equipment. The slug catcher provides a buffer volume to receive the slugs from the upstream pipeline so they do not overload the processing equipment.

Typical types of slug catchers include a vessel type slug catcher, a stored-loop type slug catcher, and a pipe type slug catcher. The vessel-type slug catcher is simply a two-phase separation vessel. For a large pipeline, many of these vessel are needed, making the vessel type of slug catcher impractical in some implementations. The stored-loop-type slug catcher uses a vessel for gas/liquid separation and stores the liquid in stored-loop-shaped fingers.

Pipe-type slug catchers are typically used for long, large-diameter pipelines. The pipe-type slug catcher has sections of large-diameter pipes or tubes, which can provide a buffer volume for the slugs and can withstand higher pressures such as encountered in large diameter pipelines. This type of slug catcher may be referred to as a finger-type or harp-type slug catcher.

The pipe-type slug catcher has an inlet arrangement that separates gas and liquids. Multiple parallel pipes are connected to a common unit and are capable receiving and buffering an arriving slug. Outlets for gas and liquid are controlled with a control system to deliver the gas and liquid to the downstream processing equipment.

The pipe-type slug catcher can be extremely difficult to clean. Typical, operators have to blow down the very large pipes (release all the contained natural gas) and either cut open or use a blind flange to open the equipment. Once open, the operator must insert a high-pressure washer into the pipes and manifolds. Other than sending a person into the confined space, which is extremely dangers and tedious, there are realistically no better ways to clean the slug catcher without blowing down the equipment in this way.

Due to increased environmental regulation and corporate stewardship, companies are shutting down and blowing down slug catchers less often. These circumstances can lead to an excessive amount of sludge, dirt, trash, and other debris collecting inside the slug catcher. The debris can cause clogging and can stop the flow of natural gas and liquids into the downstream processing equipment. Additionally, if any of this debris happens to move into the next stages of the processing equipment, the damage they cause can be expensive.

The subject matter of the present disclosure is directed to overcoming, or at least reducing the effects of, one or more of the problems set forth above.

### SUMMARY OF THE DISCLOSURE

An apparatus according to the present disclosure is directed to catching slugs of flow from a pipeline upstream of a process. The apparatus comprises an inlet, a gas outlet, one or more tubes, and a liquid outlet. The inlet is disposed in fluid communication with the pipeline and is configured to separate liquid and gas of the flow. The gas outlet is disposed in fluid communication above the inlet and is configured to output the gas. The one or more tubes extend in fluid communication below the inlet and define a volume collecting the liquid. The liquid outlet is disposed in fluid communication with the one or more tubes and is configured to output the liquid. The liquid output has at least one outlet port.

The apparatus further comprises an actuator having a mover. The mover is disposed internal to a portion of the liquid outlet. The mover is movable by the actuator in the portion of the liquid outlet and is configured to move any debris in portion of the liquid outlet relative to the at least one outlet port.

The mover can comprise at least one surface disposed internal to the portion of the liquid outlet and movable therein relative to the at least one outlet port. The actuator can be coupled to the at least one surface and can be operable to move the at least one surface inside the portion of the liquid outlet. For example, the at least one surface can comprise a paddle disposed transverse to an axis of the portion of the liquid outlet. The at least one surface can comprise a plug, a pig, a rake, a shovel, a ramp, a scraper, a scoop, or an auger.

In one example, the actuator can comprise a motor rotating a feed screw disposed inside the portion of the liquid outlet. The at least one surface, such as a paddle or the like, can be coupled to the feed screw and can be movable therealong with the rotation of the feed screw. If necessary, the actuator can comprise a gear box disposed between the motor and the feed screw.

In another example, the actuator can comprise a motor moving a belt disposed inside the portion of the liquid outlet. The at least one surface, such as a paddle or the like, can be coupled to the belt and can be movable with the movement of the belt. In yet another example, the actuator can comprise a linear actuator disposed inside the portion of the liquid outlet. The at least one surface, such as a paddle or the like, can be coupled to the linear actuator and can be movable with the movement of the linear actuator. Such a linear actuator can comprise a hydraulic piston, a pneumatic piston, or a linear motor.

In yet another example, the actuator can comprise a motor rotating a shaft disposed inside the portion of the liquid outlet. The at least one surface can be wound about the shaft, like an auger, and can be rotatable with the rotation of the shaft.

The actuator can comprise one or more of a motor, a belt, a feed screw, a cable, a piston, an arm, a rail, a rack and pinion, and a conveyor. Meanwhile, the mover can comprise a plug, a paddle, a pig, a rake, a shovel, a ramp, a scraper, a scoop, or an auger.

In a further embodiment, the apparatus can further comprise a controller operatively coupled to the actuator and controlling the movement of the mover. The controller can be programmable to control the movement of the mover based on a manual control or an automated control.

As to the apparatus, the at least one outlet port can comprise at least one liquid outlet port disposed in fluid communication with the process and configured to communicate at least a portion of the liquid with the process.

As to the apparatus, the portion of the liquid outlet can comprise a manifold defining an interior with the mover disposed therein. The interior can be configured to collect the debris and having the at least one outlet port. At least one valve can further be coupled to the at least one outlet port and can be operable to control communication of the liquid from the liquid outlet.

As to the apparatus, the one or more tubes can comprise a plurality of the one or more tubes disposed parallel to one another and having ends connected to the liquid outlet.

As to the apparatus, the liquid outlet can comprise a liquid outlet manifold and a sludge manifold. The liquid outlet manifold can be connected to one or more ends of the one or more tubes. The liquid outlet manifold can have at least one gas port disposed in fluid communication above the liquid outlet manifold, and the liquid outlet manifold can have at least one liquid port disposed in fluid communication below the liquid outlet manifold. For this part, the sludge manifold can be disposed in fluid communication below the liquid outlet manifold and can have the at least one outlet port relative to which the mover is moved.

Such a liquid outlet can further comprise at least one downcomer interconnecting the liquid outlet manifold to the sludge manifold below, and the at least one downcomer can have the at least one liquid port.

Such a liquid outlet can further comprise a vertical standpipe having an upper end connected to the liquid outlet manifold and having a lower end connected to the sludge manifold. A level sensor can be disposed on the vertical standpipe and can be configured to measure an interface of heavier and lighter types of the liquid between the liquid outlet manifold and the sludge manifold. A valve can be disposed in fluid communication with the at least one outlet of the sludge manifold. The valve can be operable to control communication of the heavier type of the liquid out of the sludge manifold based on the measured interface.

An apparatus according to the present disclosure is directed to cleaning a slug catcher. The slug catcher catches slugs of flow from a pipeline upstream of a process. The slug catcher has an outlet manifold with at least one outlet port. The apparatus comprises at least one actuator and at least one mover. The at least one actuator is mountable adjacent the outlet manifold. The at least one mover is mountable internal to a portion of the outlet manifold and is operatively coupleable to the at least one actuator. The at least one mover is movable by the at least one actuator inside the outlet manifold and is configured to move any debris in the outlet manifold relative to the at least one outlet port.

The at least one actuator and the at least one mover can be similar to those discussed above. For example, the at least one mover can comprise at least one surface disposed internal to the portion of the liquid outlet and can be movable therein relative to the at least one outlet port. The at least one actuator can be coupled to the at least one surface and can be operable to move the at least one surface inside the portion of the liquid outlet.

In one particular example, the at least one actuator can comprise a motor rotating a feed screw disposed inside the portion of the liquid outlet. The at least one surface, such as a paddle or the like, can be coupled to the feed screw and can be movable therealong with the rotation of the feed screw.

A method according to the present disclosure is directed to catching slugs of flow from a pipeline upstream of a process. The method comprises: separating liquid and gas of the flow from the pipeline upstream of the process; outputting the gas from a gas outlet to the process; outputting the liquid from a liquid outlet to the process; moving at least one surface inside a portion of the liquid outlet; and moving debris in the portion of the liquid outlet with the movement of the at least one surface relative to at least one outlet port in the liquid outlet.

In one example, the method to move the at least one surface can comprise: rotating a feed screw disposed inside the portion of the liquid outlet; and moving the at least one surface along the rotating feed screw. For example, moving the at least one surface along the rotating feed screw can comprise moving a paddle as the at least one surface disposed transverse to an axis of the feed screw. Rotating the feed screw disposed inside the portion of the liquid outlet can comprise operating a motor mounted outside the liquid outlet to rotate the feed screw.

In another example to move the at least one surface inside the portion of the liquid outlet, the method can comprise: moving a belt along an axis inside the portion of the liquid outlet; and conveying the at least one surface coupled to the belt along the axis.

In another example to move the at least one surface inside the portion of the liquid outlet, the method can comprise moving a linear actuator along an axis inside the portion of the liquid outlet, where the at least one surface can be coupled to the linear actuator and can be movable with the movement of the linear actuator.

In yet another example to move the at least one surface inside the portion of the liquid outlet, the method can comprise rotating an auger disposed in the portion of the liquid outlet, where the auger can have a winding ramp as the at least one surface.

To output the liquid from the liquid outlet to the process, the method can comprises: outputting a lighter type of the liquid from at least one liquid port disposed in fluid communication with the process; and collecting a heavier type of the liquid in a sludge chamber as the portion of the liquid outlet, the sludge chamber being disposed below the at least one liquid outlet port and having the at least one surface disposed therein, the sludge chamber defining the at least one outlet port disposed in fluid communication below the sludge chamber and configured to receive the debris.

The method can further comprise controlling communication of the lighter type of the liquid with at least one valve coupled to the at least one liquid outlet port.

Further still, the method can comprise: measuring an interface of the heavier and lighter types of the liquid between the liquid outlet port and the sludge chamber; and controlling, based on the measured interface, communication of the heavier type of the liquid with at least one valve coupled to at least one fluid outlet port of the sludge chamber.

A method according to the present disclosure is directed to cleaning a slug catcher, which catches slugs of flow from a pipeline upstream of a process. The slug catcher has an outlet manifold with at least one outlet port. The method comprises: mounting at least one mover internal to a portion of the outlet manifold; mounting at least one actuator adjacent the outlet manifold; operatively coupling the at least one actuator to the at least one mover; and moving debris in the portion of the liquid outlet manifold relative to the at least one outlet port by moving, with the at least one actuator, the at least one mover inside the portion of the outlet manifold.

The at least one actuator and the at least one mover can include any of the features discussed above. In the method, an existing outlet manifold on the slug catcher can be replace with an outlet manifold having the at least one mover. Alternatively in the method, the existing outlet manifold may not be replaced. Instead, an interior of the existing outlet manifold can be accessed so the at least one mover can be installed therein.

The foregoing summary is not intended to summarize each potential embodiment or every aspect of the present disclosure.

### BRIEF DESCRIPTION OF THE DRAWINGS

FIG. 1A illustrates a side elevational view of a slug catcher having a cleaning apparatus of the present disclosure.

FIG. 1B illustrates a side elevational view of another slug catcher having a cleaning apparatus of the present disclosure.

FIG. 1C illustrates a side elevational view of yet another slug catcher having a cleaning apparatus of the present disclosure.

FIG. 2A illustrates an end elevational view of a first cleaning apparatus of the present disclosure incorporated into components of a slug catcher.

FIG. 2B illustrates a side sectioned view of the first cleaning apparatus of the present disclosure incorporated into components of the slug catcher.

FIGS. 3A-3E illustrate various movers for use with the disclosed cleaning apparatus.

FIG. 4A illustrates a support bearing for the disclosed cleaning apparatus.

FIG. 4B illustrates a feed screw, couplings, and a second bearing for the disclosed cleaning apparatus.

FIG. 4C illustrates a cross-sectional view of a high pressure seal for the feed screw.

FIG. 4D illustrates a gear box for the disclosed cleaning apparatus.

FIG. 5 illustrates an end elevational view of a second cleaning apparatus of the present disclosure incorporated into components of a slug catcher.

FIGS. 6A-6C illustrates schematic views of additional cleaning arrangements of the present disclosure incorporated into components of a slug catcher.

### DETAILED DESCRIPTION OF THE DISCLOSURE

As disclosed herein, a cleaning apparatus uses an internal mechanical system to clean a pipe-type slug catcher, such as a finger-type or a harp-type slug catcher having storage tubes. The cleaning apparatus utilizes a mover (e.g., surface, paddle, auger, etc.) inside a manifold of the pipe-type slug catcher. During operation of the slug catcher, debris from the storage tubes is collected in the manifold. The debris can in general include any fouling, sludge, solids, sand, and the like. The mover (e.g., surface, paddle, auger, etc.) sits in the manifold and is moved inside the manifold's interior as needed to move any debris at least relative to an outlet port of the manifold. Preferably, the mover moves the debris toward the outlet port for removal of contents through the port. In some situations where clogging has occurred of an outlet port, the mover can move the debris away from the outlet port so liquid, such as water, can be removed from the manifold. The cleaning apparatus can be incorporated into a liquid outlet manifold and/or a sludge manifold of the pipe-type slug catcher. The cleaning apparatus can be operated manually, can be automated to run at predetermined times, or can be started by an operator as needed.

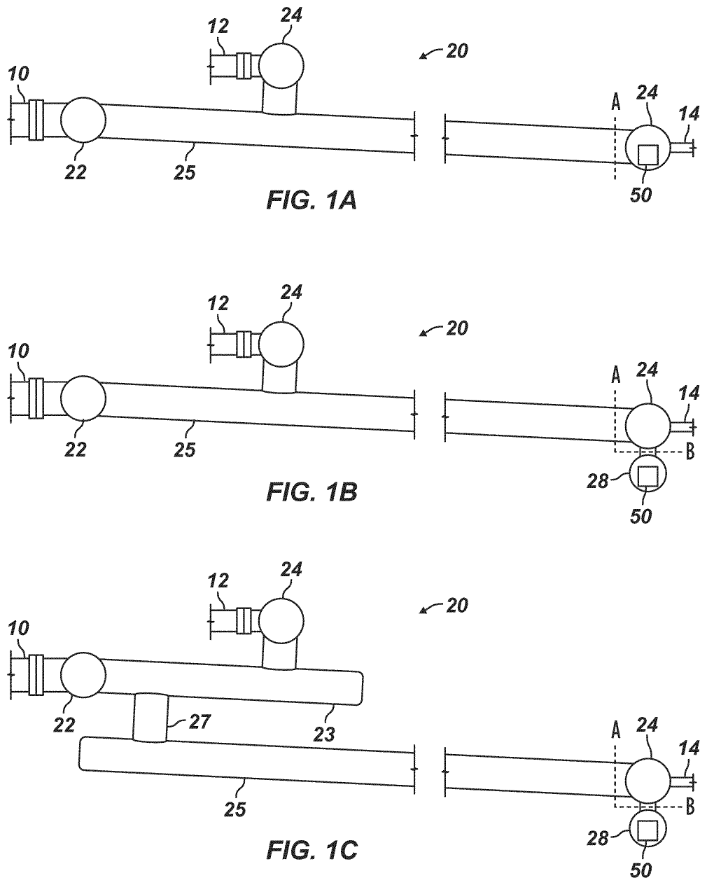

FIG. 1A illustrates a side elevational view of a slug catcher 20 having a cleaning apparatus 50 of the present disclosure. The slug catcher 20 is used for catching flow from a pipeline (not shown) upstream, and the slug catcher 20 is disposed upstream of a process (not shown). In general, the flow from the pipeline can include multi-phase flow and can have a number of constituents depending on the purposes of the pipeline and the source of the flow. In general, the flow from the pipeline can include raw natural gas. Also, natural gas liquids, condensate, water, and other compounds may be present in the flow. In general, natural gas liquids (NGLs) include ethane, propane, butane, iso-butane, natural gasoline, etc. As is typical, raw natural gas may contain water vapor, hydrogen sulfide (H₂S), carbon dioxide, helium, nitrogen, and other compounds.

The slug catcher 20 includes an inlet 22, a gas outlet 24, one or more tubes 25, and a liquid outlet 26. The inlet 22 is disposed in fluid communication via a flow connection 10 with the flow from the pipeline (not shown). The flow enters the inlet 22, which can be a splitter, a distributor, or a manifold. The inlet 22 distributes the flow to the one or more tubes 25. Here, the slug catcher 20 is a pipe type slug catcher having multiple storage tubes or pipes 25 (i.e., fingers) arranged in parallel.

The inlet 22 is configured to separate liquid and gas from the multi-phase flow. The gas outlet 24 is disposed in fluid communication above the inlet 22 and connects via risers to the storage tubes 25. The gas outlet 24 can also be a manifold, which collects dry gas and is configured to output the separated gas to a gas connection 12.

The storage tubes 25 extend in fluid communication below the inlet 22 and define a volume for collecting and storing separated liquid. Typically, the tubes 25 are arranged at a grade to promote gas to rise toward the gas outlet 24 and to promote liquid to collect toward the liquid outlet 26.

The liquid outlet 26 is disposed in fluid communication with the storage tubes 25. The liquid outlet 26 is preferably a manifold connected to the ends of the multiple tubes 25 to collect the liquid. The liquid outlet 26 is configured to output the separated liquid to a liquid connection 14. Consequently, the gas from the gas outlet 24 can pass through the gas connection 12 to downstream processing, and the liquid from the liquid outlet 26 can pass through the liquid connection 14 to additional downstream processing.

A cleaning apparatus 50 of the present disclosure is disposed internal to a portion of the liquid outlet 26. As will be discussed in more detail below, a mover of the cleaning apparatus 50 is movable inside the liquid outlet 26 and is configured to move fouling (e.g., debris, sludge, and the like) relative to an outlet port in the liquid outlet 26.

As shown in FIG. 1A, the cleaning apparatus 50 can be incorporated directly into the liquid manifold of the liquid outlet 26 connected to the storage tubes 25. In one arrangement, a new liquid manifold having the cleaning apparatus 50 incorporated therein can replace an existing liquid manifold of the liquid outlet 26 for the slug catcher 20. For example, the existing manifold can be removed from the ends of the storage tubes 25, such as at line A, and the new liquid manifold for the liquid outlet 26 having the cleaning apparatus 50 can be attached in its place. Alternatively, the cleaning apparatus 50 can be installed or retrofitted into an existing liquid manifold of the liquid outlet 26 for the slug catcher 20. These and other arrangements can be made.

FIG. 1B illustrates a side elevational view of another slug catcher 20 having a cleaning apparatus 50 of the present disclosure. This slug catcher 20 is similar to that discussed above so details are not repeated. Here, the liquid outlet 26 of this slug catcher 20 includes a sludge manifold 28, which is disposed in fluid communication below the liquid manifold of the outlet 26. In contrast to the previous arrangement, the cleaning apparatus 50 of the present disclosure disposed internal to a portion of the liquid outlet 26 is incorporated into the sludge manifold 28. As will be discussed in more detail below, a mover of the cleaning apparatus 50 is movable inside the sludge manifold 28 and is configured to move fouling (e.g., debris, sludge, and the like) relative to an outlet port in the sludge manifold 28.

As an alternative, the cleaning apparatus 50 can be incorporated directly into the liquid manifold of the liquid outlet 26 connected to the storage tubes 25 instead of being incorporated into the sludge manifold 28 as shown. Further still, both the liquid manifold and the sludge manifold 28 of the outlet 26 can include a cleaning apparatus 50 of the present disclosure.

In one arrangement, a new liquid outlet 26 having the cleaning apparatus 50 can replace an existing liquid outlet 26 for the slug catcher 20. For example, the existing liquid outlet 26 can be removed from the ends of the storage tubes 25, such as at line A, and the new liquid outlet 26 having the sludge manifold 28 and the cleaning apparatus 50 incorporated therein can be attached in its place. Alternatively, the existing sludge manifold 28 can be removed from the liquid manifold of the outlet 28, such as at line B, and a new sludge manifold 28 having the cleaning apparatus 50 incorporated therein can be attached in its place. Further still, the cleaning apparatus 50 can instead be installed or retrofitted into the existing sludge manifold 28 for the slug catcher 20. These and other arrangements can be made.

FIG. 1C illustrates a side elevational view of yet another slug catcher 20 having a cleaning apparatus 50 of the present disclosure. This slug catcher 20 is similar to those discussed above so details are not repeated. In fact, the liquid outlet 26 can be comparably configured to the arrangements discussed above.

In contrast to the other arrangements, the inlet 22 and the gas outlet 24 of this slug catcher 20 include a different configuration. Here, separation tubes 23 extend from the inlet 22. The gas outlet 24 connects toward the downstream ends of these separation tubes 23, while downcomers 27 towards the upstream ends of these separation tubes 23 communicate to the storage tubes 25 below.

As will be appreciated by one skilled in the art having the benefit of the present disclosure and the examples of FIGS. 1A-1C, the slug catcher 20 can have any number of separation tubes 23, storage tubes 25, risers, downcomers 27, and the like and can have liquid outlets 26 with liquid manifolds and optionally sludge manifolds 28. Multiple slug catchers 20 can be used together, and various interconnections and feedback connections for liquid and gas can be used, as will be appreciated by those skilled in the art.

Having an understanding of the slug catcher 20 and the cleaning apparatus 50 of the present disclosure, discussion turns to particular arrangements according to the present disclosure.

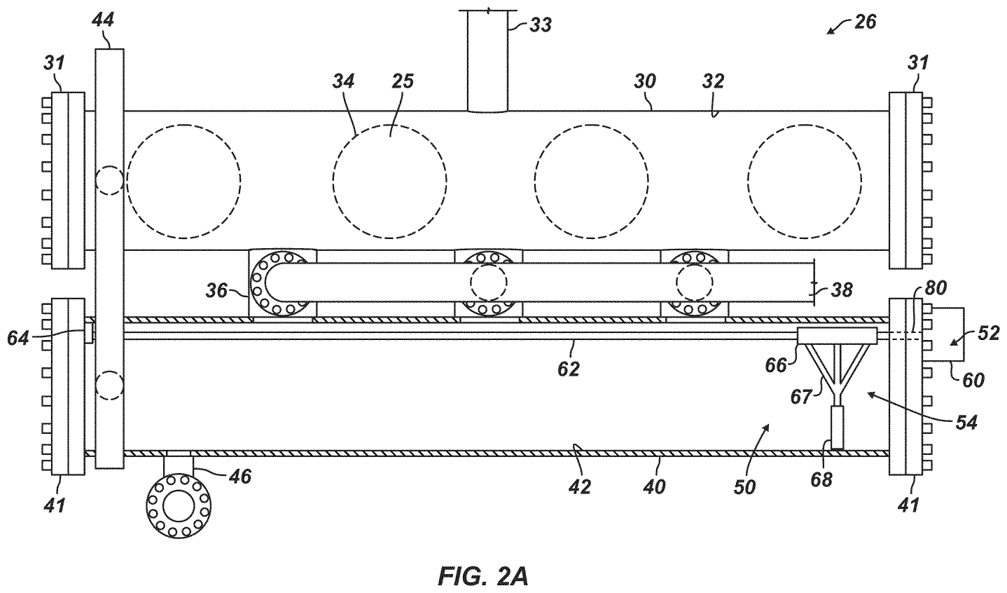

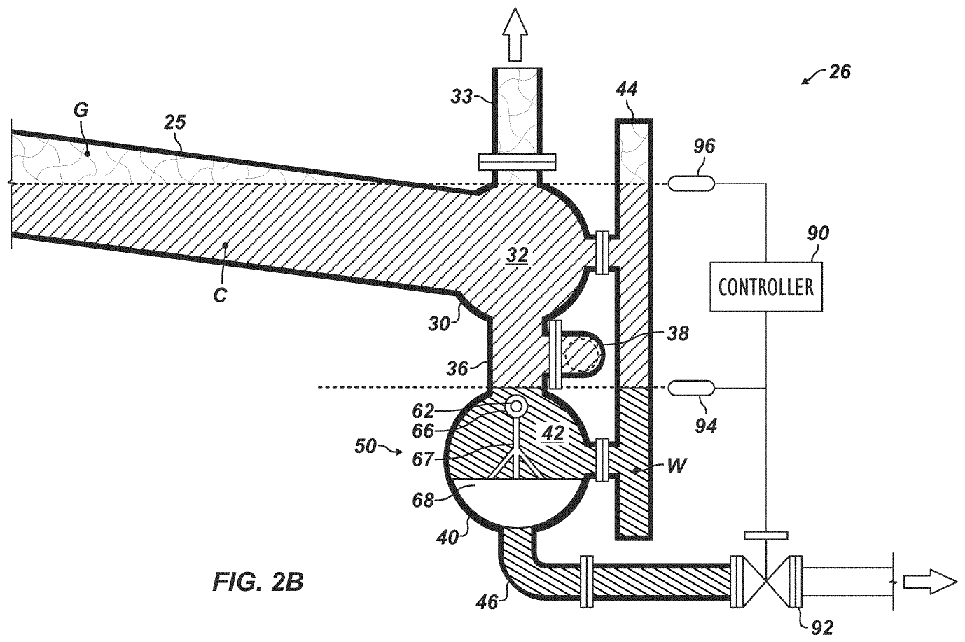

FIG. 2A illustrates an end elevational view of a first cleaning apparatus 50 of the present disclosure incorporated into components of a liquid outlet 26 for a slug catcher, such as discussed above. FIG. 2B illustrates a side sectioned view of the first cleaning apparatus 50.

As shown in FIG. 2A, the liquid outlet 26 includes a liquid manifold 30 connected to the ends of the storage tubes 25 with the interior 32 of the manifold 30 having side openings 34 communicating with the storage tubes 25. The liquid manifold 30 is tubular and runs laterally across the parallel storage tube 25, of which four are shown in this example. Ends of the manifold's interior 32 are sealed with end walls or end caps 31. Preferably, one of the ends provides access to the interior 32 through a removable end cap 31. The liquid manifold 30 has one or more gas outlet ports 33 disposed in fluid communication above the interior 32 for passage of gas. The liquid manifold 30 also has one or more liquid outlet ports or downcomers 36 disposed in fluid communication below the manifold's interior. Here, three downcomers 36 are shown, and each includes a side port connecting to a liquid connection 38 for communicating liquid further downstream for processing.

As also shown in FIG. 2A, the liquid outlet 26 includes a sludge manifold 40 disposed in fluid communication below the liquid manifold 30 via these downcomers 36. Similar to the liquid manifold 30, the sludge manifold has an interior 42 and is tubular, running laterally parallel to the liquid manifold 30. Ends of the manifold's interior 42 are sealed with end walls or end caps 41. Preferably, one of the ends provides access to the interior 42 through a removable end cap 41. The interior 42 communicates with at least one outlet port 46 for communication of fouling, sludge, debris, water, and the like further downstream for handling. The at least one outlet port 46 can be a port dedicated only for debris removal, in which case another outlet port (not shown) can be provided in the manifold 40 for conventional draining of water or other liquid. Alternatively, the at least one outlet port 46 can be a port for both debris removal and for conventional draining of water or other liquid.

In the present arrangement, the cleaning apparatus 50 is disposed internal to the sludge manifold 40. Overall, the apparatus 50 includes an actuator 52 and a mover 54. The mover 54 has at least one surface disposed internal to the sludge manifold 40 and is movable, with the operation of the actuator 52, in the manifold's interior 42 relative to the at least one outlet port 46. In this way, the actuator 52 is coupled to the mover 54 and is operable to move the at least one surface of the mover 52 inside the sludge manifold 50.

A number of arrangements of the cleaning apparatus 50 disclosed herein can be incorporated into the sludge manifold 40. Based on comments above, the liquid manifold 30 may also include (or may alternatively include) the cleaning apparatus 50.

In the present arrangement, the actuator 52 includes a motor 60 having a feed screw 62 that passes through the interior 42 of the sludge manifold 40. As shown, the motor 60 can be mounted external to the interior 42, but can be placed elsewhere. In one example, the motor 60 can be mounted on the end cap 41 of the manifold 40. The feed screw 62 passes through the end cap 41 with a seal 80, and the feed screw 62 extends along the length of the interior 42 to the opposing end cap 41. A bearing arrangement 64 supports the distal end of the feed screw 62. This bearing arrangement 64 can be mounted inside the interior 42, can be mounted on the opposing end cap 41, or can be mounted outside the opposing end cap 41. Any passage through the opposing end cap 41 for the feed screw 62 is sealed with a seal (not shown) to prevent escape of fluids.

The feed screw 62 can be positioned at the 12-o′clock position or may be offset to avoid fouling of the feed screw 62. Otherwise, the downcomers 36 communicating into the sludge manifold 40 may be offset.

The mover 54 includes a traveling block 66 threaded on the feed screw 62 so that rotation of the feed screw 62 in either direction moves the traveling block 66 back and forward in the interior 42 along the feed screw 62. The surface of the mover 54 in this arrangement is a paddle 68 connected by arms or supports 67 to the traveling block 66. The surface of the paddle 68 is disposed transverse to an axis of the manifold 40 so movement of the paddle 68 can move (push/pull) debris in the interior 42. The paddle 68 is preferably composed of a suitable pigging material, such as urethane so as to avoid scraping or damage to the interior 42 of the manifold 40.

According to previous descriptions, the cleaning apparatus 50 having the paddle 68 can be installed or retrofitted into an existing sludge manifold 40. For example, components of the cleaning apparatus 50 can be installed through a removable end cap 41. Alternatively, an existing sludge manifold 40 (and optionally the liquid manifold 30 as well) can be removed and replaced with new components having the cleaning apparatus 50 incorporated therein. Either way, access can be gained to repair and replace components of the apparatus 50 via the removable end cap 41.

As shown in the sectioned view of FIG. 2B, the storage tubes 25 of the slug catcher store liquid. The stored liquid collects in the liquid manifold 30 at the end of the storage tubes 25. Depending on the constituents present, the flow may have lighter and heavier liquid components. For example, the liquid can separate between water W and condensate or natural gas liquid C. Gas G can collect in the upper end of the storage tubes 25 for output. The liquid manifold 30 can include a gas outlet port 33 disposed in communication above the manifold 30, which can feedback to other components of the slug catcher. The downcomers 36 from the liquid manifold 30 have side ports for the liquid (e.g., the condensate C) to pass out through the liquid connection 38.

The mover 52 is shown inside the sludge manifold 40, which is shown face on in this sectioned view. The traveling block 66 is disposed on the feed screw 62, and the paddle 68 extends to the lower half of the interior 42 on the arms or supports 67. The paddle 68 can be half of a disk for scrubbing the bottom surface of the sludge manifold's interior 42. The paddle 68 can have other shapes and can scrub more of less circumference of the interior 42. The outlet port 46 from the sludge manifold 40 can conduct water and debris (sludge) from the interior 42.

A controller 90 can be used with a control valve 92 and one or more sensors 94, 96 to maintain liquid (e.g., water W) in the sludge manifold 40 and to ensure liquid (e.g., condensate C) can communicate out the liquid connection 38. A vertical standpipe or bridle 44 connects the liquid manifold's interior 32 with the sludge manifold's interior 42.

As already noted above, the liquid encountered by the slug catcher can include heaver and lighter types. The one or more sensors 94, 96 disposed on the vertical standpipe 44 can be configured to measure an interface of the heavier and lighter types of the liquid between the liquid manifold 30 and the sludge manifold 40. For example, the one or more sensors 94, 96 can measure the levels of the condensate C and water W in the standpipe 44.

In general, one sensor 94 can be a water level gage, such as a magnetic level gage having a low level switch, and connected to the level controller 90. The level controller 90 is in operable communication with the level valve 92 in fluid communication with the outlet 46 of the sludge manifold 40. For its part, the other sensor 96 can be a condensate level gage, such as a magnetic level gage having a high level switch and a low level switch, and connected to the level controller 90. In turn, the level controller 90 can connect to another level or output valve (not shown) controlling communication from the outlet connection 38.

During operation, the storage tubes 25 can store liquid from slugs. The level controller 90 can then control communication of the liquid (such as the condensate C) from the outlet connection 38 in a controlled fashion so as not to over burden downhole processing equipment.

During operation, the level controller 90 can also control communication of the liquid (such as the water W) from the outlet 46. Preferably, water W is maintained in the sludge manifold 40 so any debris can be passed out the outlet 46 with water when output from the manifold 40.

On a periodic basis at least, the cleaning apparatus 50 can be operated with the water W present in the manifold 46 to move any debris in the interior 42 relative to the outlet 46. For example, the feed screw 62 can be rotated within the manifold 40, and rotation of the feed screw 62 moves the paddle 68 along the feed screw's length. The paddle 68 travels between the distal end and the proximal end of the feed screw 62 to either push/pull sludge in the interior 42.

In its movement, the paddle 68 can move any debris in the interior 42 to the outlet 46 so the debris can pass out the outlet 46 with the opening of the valve 92. Alternatively, the paddle 68 can move debris in the interior 42 away from the outlet 46 so the debris does not clog the outlet 46 for passage of liquid. Likewise, the paddle 68 can be moved in the interior 42 to agitate, break-up, etc. any debris in the interior 42 so that it can pass with the water W out the outlet 46.

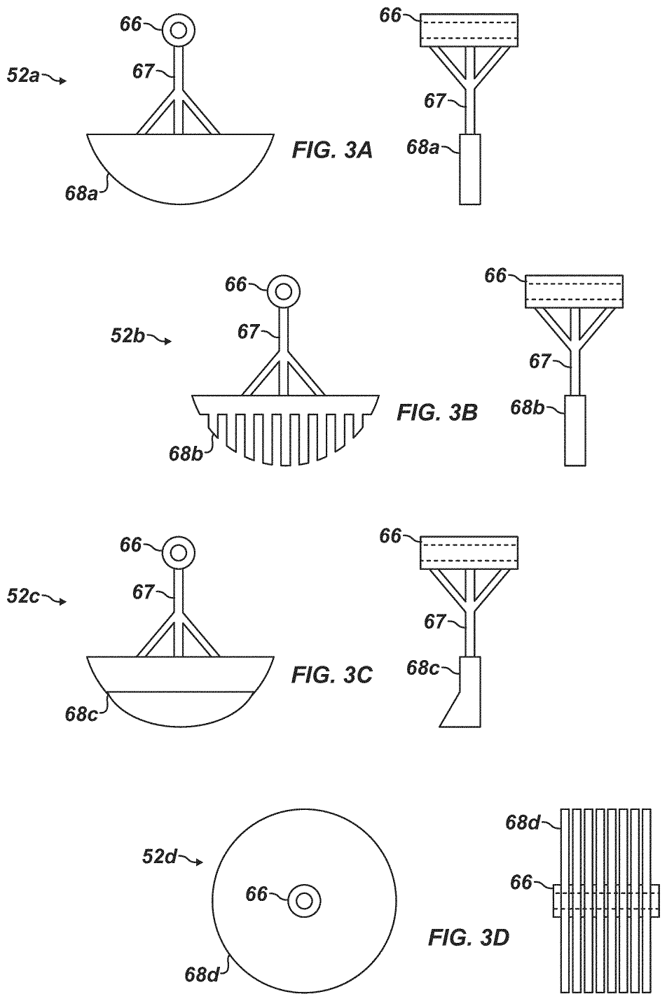

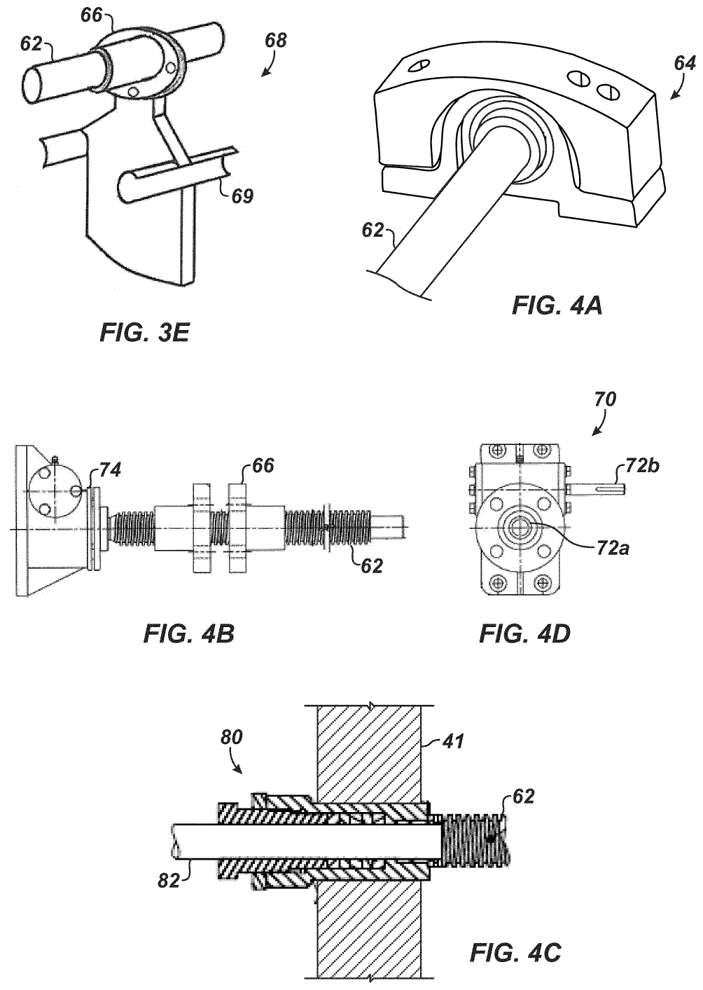

As disclosed herein, the at least one surface of the mover 54 can include a paddle. Various configurations are possible for the mover 54. As some examples, FIGS. 3A-3E illustrate various movers 54a-d for use with the disclosed cleaning arrangements.

The mover 54a in FIG. 3A has a paddle 68a as discussed above connected by arms or supports 67 to a traveling block 66. The paddle 68a can be a partial disk with a flat surface. The mover 54b in FIG. 3B has a rake 68b connected by arms 67 to the traveling block 66, while the mover 54c in FIG. 3C has a shovel or scoop 68c connected by arms 67 to the traveling block 66.

In FIG. 3D, the mover 54d has the shape of a pig with flat discs 68d of urethane or other appropriate material mounted on the traveling block 66. Finally, any of the movers 54 disclosed herein can include one or more guides or supports, such as the guides 69 disposed on the paddle 68 in FIG. 3E, to guide the movement of the mover 54. As these examples will show, a number of configurations for the mover 54 can be used for the disclosed cleaning apparatus 50.

As noted above, the cleaning apparatus 50 of FIGS. 2A-2B includes the feed screw 62 installed inside the manifold 40. The feed screw 62 can be composed of stainless steel. At its distal end, the feed screw 62 is supported by the bearing assembly 64, which can attach to the internal wall of the manifold 40. As shown in FIG. 4A, the bearing assembly 64 can be a pillow block, which is mounted to the inner manifold wall to support the distal end of the feed screw 62.

As shown in FIG. 4B, the proximal end of the feed screw 62 can be supported by a secondary bearing assembly 74, which can be mounted in the manifold (40). As also shown, the traveling block 66 can include a pair of threaded couplings, which are movably threaded on the feed screw 62 and can affix together against support arms or other elements of the mover 54 (i.e., paddle 68).

As shown in FIG. 4C, the feed screw 62 can exit the end cap (41) with a seal 80, which can be a pressure seal. In general, the seal 80 of FIG. 4C can be created in several ways, including but not limited to one or more of: an O-ring type seal being of either conventional or one of the many existing varieties of cross-section, a lip-type rotary seal, or a conventional stuffing box arrangement (e.g., a gland-type of stuffing box seal).

For the gland-type seal, a loosely braided or otherwise deformable sealing material is layered in a cavity around a polished rod 82 of the feed screw 62 passing through the end cap (41). A packing gland/nut, which generates a large force along the axis of the polished rod 82, is used to compress the seal material within the cavity causing it to exert pressure against the cavity wall and rod surface. Sufficient force is applied so that the compression forces of the packing material exceed the pressure being contained and leakage is prevented. As will be appreciated, the sealing and packing area of the seal 80 can be incrementally increased based on the specified pipeline pressures and other requirements of an implementation.

The end 82 of the feed screw 62 extending beyond the seal 80 can connect to an output shaft 72b of a gear box 70, such as shown in FIG. 4D. An input gear box shaft 72a can be utilized to install the motor (60) for fully-automated or semi-automated embodiments. Alternatively, the gear box shaft 72a can be hand-operated for manual capabilities.

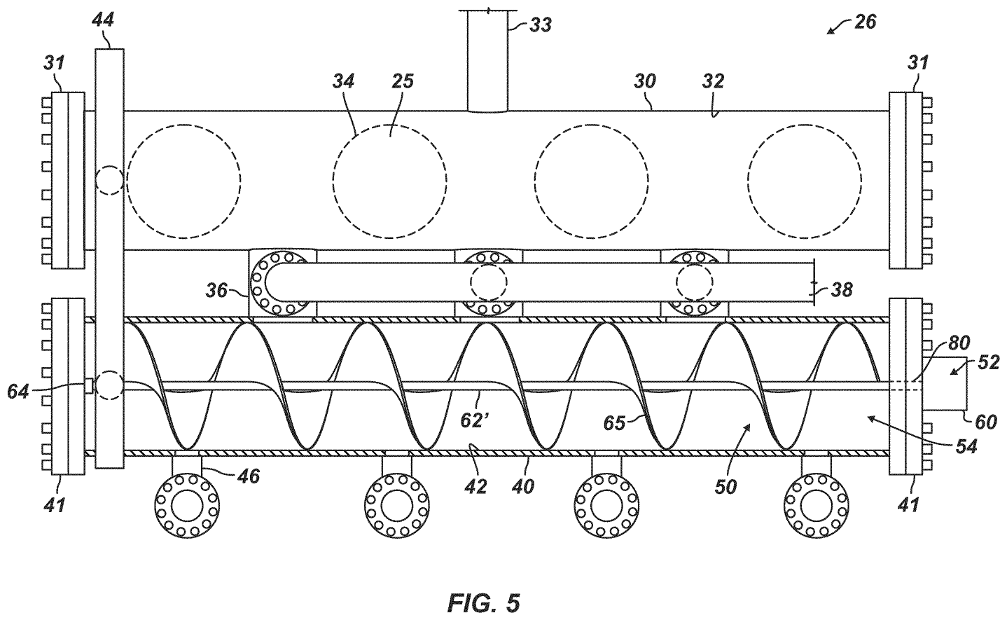

In the arrangements discussed above, the at least one surface of the cleaning apparatus 50 movable in the interior 42 of the manifold 40 can include a paddle 68. As discussed herein, other arrangements can be used. For example, FIG. 5 illustrates an end elevational view of a second cleaning apparatus 50 of the present disclosure incorporated into components of a liquid outlet 26 of a slug catcher.

Similar to the previous arrangement, the liquid outlet 26 includes a sludge manifold 40, which is disposed below the liquid manifold 30 and which has the cleaning apparatus 50 incorporated therein. Here, the actuator 52 includes a motor 60 having a shaft 62′ that passes through the interior 42 of the sludge manifold 40. As shown, the motor 60 can be mounted external to the interior 42. For example, the motor 60 can be mounted on the end cap 41 of the manifold 40. The shaft 62′ passes through the end cap 41 with a seal 80, and the shaft 62′ extends along the length of the interior 42 to the opposing end cap 41. A bearing arrangement 64 supports the distal end of the shaft 62′. This bearing arrangement 64 can be mounted inside the interior 42, can be mounted inside the end cap 41, or can be mounted outside the end cap 41. Any passage through the end cap 41 for the shaft 62′ is sealed with a packing seal to prevent escape of fluids.

In the present arrangement, the surface of the mover 54 for moving the sludge in the interior 42 includes an auger 65, which can be composed of a suitable material such as urethane. Rotation of the auger's winding surface in either direction can move sludge back and forth in the interior 42. Several outlets 46 may be disposed along the length of the sludge manifold 40. Because the winding surface of the auger 65 can make multiple contacts within the interior, rotation of the auger 65 can move more debris and can move it in shorter distances to clean the interior 42. The diameter of the auger 65 can be about or can be less than the internal diameter of the interior 42. However, the auger 65 preferably scrubs at least the bottom surface of the interior 42 of the manifold 40 where sludge tends to collect.

Similar to previous descriptions, the cleaning apparatus 50 having the auger 65 can be installed or retrofitted into an existing sludge manifold 40. For example, components of the cleaning apparatus 50 can be installed through a removable end cap 41. Alternatively, an existing sludge manifold 40 (and optionally the liquid manifold 30 as well) can be removed and replaced with new components having the cleaning apparatus 50 incorporated therein. Either way, access can be gained to repair and replace components of the apparatus 50 via the removable end cap 41.

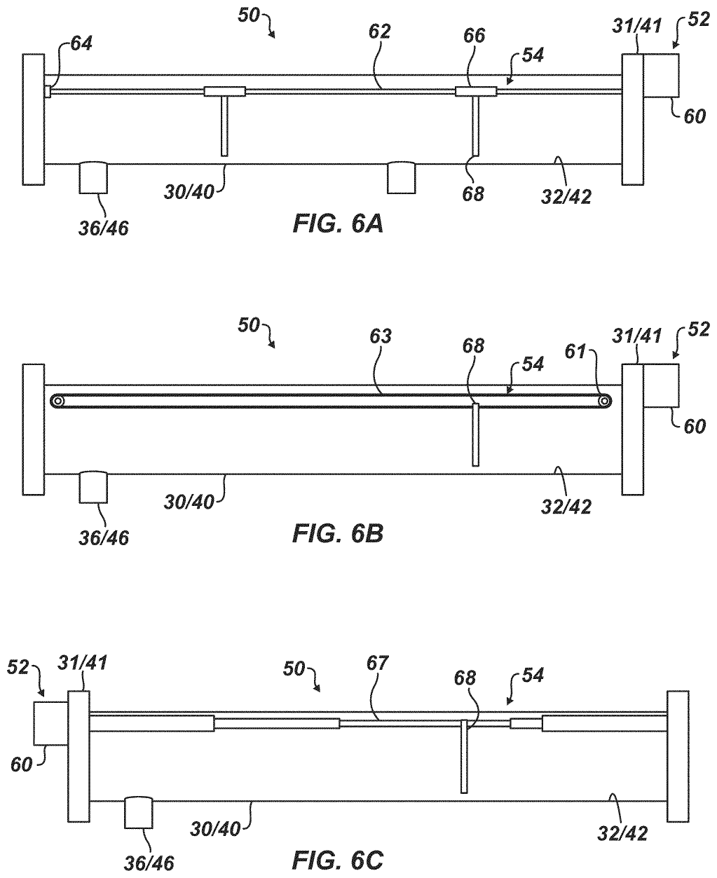

In addition to those discussed above, additional arrangements can be used for the cleaning apparatus 50. As shown in FIG. 6A, the apparatus 50 can use multiple movers 54 with the actuator 52 to move debris (sludge) in the interior of the manifold, which can be either a liquid manifold 30 or a sludge manifold 40. Here, multiple paddles 68 can be used on the feed screw 62 connected to the motor 60.

Although a rotatable feed screw 62 and paddle 68 have been disclosed above for the apparatus 50, other actuators 52 and movers 54 can be used to move sludge along the length of the mandrel 40. In this regard, hydraulic or pneumatic cylinders can have arms that move inside the manifold 30/40 and can push and/or pull the paddle 68 inside the mandrel 40. The paddle 68 may be supported on rails or the like. Alternatively, a rack and pinion system can be used.

For example, FIG. 6B shows an example of the cleaning apparatus 50 having a motor 60 that rotates a drive belt 63 with a gear 61 for the actuator 52. Forward and reverse rotation of the gear 61 can move a paddle 68 for the mover 54 on the belt 63 back and forth in the interior 42 of the manifold 40. As will be appreciated, connection of the gear 61 with the motor 60 through the manifold 30/40 can include a seal.

FIG. 6C shows another example of the cleaning apparatus 50 having a motor 60 that moves a linear actuator 67 for the actuator 52. For example, the motor 60 can be hydraulic, pneumatic, or the like, and the linear actuator 67 can be a piston or the like. Alternatively, the linear actuator 67 can itself be a linear motor. Extension and retraction of the linear actuator 67 can move a paddle 68 for the mover 54 back and forth in the interior 42 of the manifold 40. As will be appreciated, connection of the linear actuator 67 with the motor 60 or other external element through the manifold 30/40 can include a seal.

As the various cleaning apparatus 50 disclosed herein will show, a number of different mechanisms for the actuator 52 and mover 54 that actuate and move at least one surface in the manifold 30/40 can be used. In general, the actuator 52 can include one or more of a motor, a belt, a feed screw, a cable, a cylinder, an arm, a rail, a rack and pinion, a conveyor, and the like. In general, the at least one surface of the mover 54 can be a plug, a paddle, a pig, a rake, a shovel, scoop, a scraper, a winding ramp of an auger, and the like. Accordingly, these and other alternatives of the disclosed cleaning apparatus 50 can be used to move any sludge inside the sludge manifold 30/40.

As noted above, the cleaning apparatus 50 uses an actuator 52 to move a mover 54 to move inside an interior of a manifold. The actuator 52 can be operated manually, semi-automatically, and automatically to move the mover 54. To operate the cleaning apparatus 50 manually, for example, operators can manually operate a shaft 72a of a gear box 70 with a wrench or a drill motor to move the mover 54 (i.e., move the paddle 68 along the feed screw 62, rotate the auger 65 about the shaft 62′, etc.). In this manual operation, the travel distance of the paddle 68, rotation of the auger 65, etc. is controlled by the number of turns made to the extended gear shaft 72a.

To operate the cleaning apparatus 50 automatically or semi-automatically, the actuator 52 can use a motor 60, which is connected to a gear shaft 72a of a gear box 70 as noted above. Operation of the motor 60 can move the mover 54 (i.e., move the paddle 68 along the feed screw 62, rotate the auger 65 about the shaft 62′, etc.).

In any of the disclosed arrangements of the cleaning apparatus 50, the motor 60 can be an explosion-proof electric motor, although other drives can be used. For example, a hydraulic motor 60 can be used, but may require a pneumatic supply gas to operate/actuate the cleaning apparatus 50. Most pneumatic supply gases are provided by natural gas from the pipeline so a pump can drive the hydraulics. There may be methane emissions as the pneumatic pump strokes so using an electric motor 60 can eliminate such methane emissions.

The motor 60 can be controlled semi-automatically by an operator with an ON/OFF switch. Alternatively, the motor 60 can be controlled automatically by programmed logic of a controller (e.g., 90 of FIG. 2B) for automated operation. For example, the motor 60 can be connected to the controller 90 having a programmable logic controller and a display. The controller 90 can be operable to actuate the motor 60 based on pre-programmed time intervals, local operation commands, remote operation commands, or other automated control scheme.

In general, the controller 90 can include a control panel, which can display control screens to program the specific cleaning interval, cleaning time, remote actuation, or other operation. In turn, the controller 90 controls the actuator 52 (motor 60) and the amount of movement of the mover 54. In short, the controller 90 controls the actuation of the cleaning apparatus 50 for the fully-automated operation.

The controller 90 can have an Ethernet or other connection to remotely access the cleaning apparatus 50 to monitor performance and/or control the cleaning of the liquid outlet. The controller 90 may have connections to (or may use any signals from) flow sensors, level gauges, or other sensing equipment, and the controller 90 can use such signals to control operation of the cleaning apparatus 50 automatically.

Although the cleaning apparatus 50 of the present disclosure is disclosed specifically for use with the liquid outlet of a slug catcher, such as the liquid outlet manifold and/or sludge manifold, it will be appreciated with the benefit of the present disclosure that the cleaning apparatus can be used with other portions, other outlets, other manifolds, etc. of a slug catcher where debris (sludge) may collect.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. An apparatus for catching slugs of flow from a pipeline upstream of a process, the apparatus comprising:
an inlet disposed in fluid communication with the pipeline and configured to separate liquid and gas of the flow;
a gas outlet disposed in fluid communication above the inlet and configured to output the gas;
one or more tubes extending in fluid communication below the inlet and defining a volume collecting the liquid;
a liquid outlet disposed in fluid communication with the one or more tubes and configured to output the liquid, the liquid output having at least one outlet port; and
an actuator having a mover, the mover disposed internal to a portion of the liquid outlet, the mover being movable by the actuator in the portion of the liquid outlet and being configured to move any debris in portion of the liquid outlet relative to the at least one outlet port.

2. The apparatus of claim 1, wherein:
the mover comprises at least one surface disposed internal to the portion of the liquid outlet and being movable therein relative to the at least one outlet port; and
the actuator is coupled to the at least one surface and is operable to move the at least one surface inside the portion of the liquid outlet.

3. The apparatus of claim 2, wherein the at least one surface comprises a paddle disposed transverse to an axis of the portion of the liquid outlet.

4. The apparatus of claim 1, wherein the actuator comprises a motor rotating a feed screw disposed inside the portion of the liquid outlet; and wherein the mover comprises at least one surface coupled to the feed screw and being movable therealong with the rotation of the feed screw.

5. The apparatus of claim 1, wherein one of:
the actuator comprises a motor moving a belt disposed inside the portion of the liquid outlet, the mover comprising at least one surface coupled to the belt and being movable with the movement of the belt;
the actuator comprises a linear actuator disposed inside the portion of the liquid outlet, the mover comprising at least one surface coupled to the linear actuator and being movable with the movement of the linear actuator; and
the actuator comprises a motor rotating a shaft disposed inside the portion of the liquid outlet, the mover comprising at least one surface wound about the shaft and being rotatable with the rotation of the shaft.

6. The apparatus of claim 1, wherein the actuator comprise one or more of a motor, a belt, a feed screw, a cable, a piston, an arm, a rail, a rack and pinion, and a conveyor; and wherein the mover comprises a plug, a paddle, a pig, a rake, a shovel, a ramp, a scraper, a scoop, or an auger.

7. The apparatus of claim 1, further comprising a controller operatively coupled to the actuator and controlling the movement of the mover.

8. The apparatus of claim 7, wherein the controller is programmable to control the movement of the mover based on a manual control or an automated control.

9. The apparatus of claim 1, wherein the at least one outlet port comprises at least one liquid outlet port disposed in fluid communication with the process and configured to communicate at least a portion of the liquid with the process.

10. The apparatus of claim 1, wherein the portion of the liquid outlet comprises a manifold defining an interior with the mover disposed therein, the interior configured to collect the debris and having the at least one outlet port.

11. The apparatus of claim 10, further comprising at least one valve coupled to the at least one outlet port and being operable to control communication of the liquid from the liquid outlet.

12. The apparatus of claim 1, wherein the liquid outlet comprises:
a liquid outlet manifold connected to one or more ends of the one or more tubes, the liquid outlet manifold having at least one gas port disposed in fluid communication above the liquid outlet manifold, the liquid outlet manifold having at least one liquid port disposed in fluid communication below the liquid outlet manifold; and
a sludge manifold disposed in fluid communication below the liquid outlet manifold and having the at least one outlet port.

13. The apparatus of claim 12, wherein the liquid outlet manifold comprises at least one downcomer interconnecting the liquid outlet manifold to the sludge manifold below, the at least one downcomer having the at least one liquid port.

14. The apparatus of claim 12, further comprising:
a vertical standpipe having an upper end connected to the liquid outlet manifold and having a lower end connected to the sludge manifold;
a level sensor disposed on the vertical standpipe and configured to measure an interface of heavier and lighter types of the liquid between the liquid outlet manifold and the sludge manifold; and
a valve disposed in fluid communication with the at least one outlet of the sludge manifold, the valve being operable to control communication of the heavier type of the liquid out of the sludge manifold based on the measured interface.

15. An apparatus to clean a slug catcher, the slug catcher catching slugs of flow from a pipeline upstream of a process, the slug catcher having an outlet manifold with at least one outlet port, the apparatus comprising:
at least one actuator mountable adjacent the outlet manifold; and
at least one mover mountable internal to a portion of the outlet manifold and operatively coupleable to the at least one actuator, the at least one mover being movable by the at least one actuator inside the outlet manifold and configured to move any debris in the outlet manifold relative to the at least one outlet port.

16. The apparatus of claim 15,
wherein the at least one mover comprises at least one surface disposed internal to the portion of the liquid outlet and being movable therein relative to the at least one outlet port; and
wherein the at least one actuator is coupled to the at least one surface and is operable to move the at least one surface inside the portion of the liquid outlet.

17. The apparatus of claim 16, wherein the at least one surface comprises a paddle disposed transverse to an axis of the portion of the liquid outlet.

18. The apparatus of claim 15, wherein the at least one actuator comprises a motor rotating a feed screw disposed inside the portion of the liquid outlet; and wherein the at least one mover comprises at least one surface coupled to the feed screw and being movable therealong with the rotation of the feed screw.

19. A method of catching slugs of flow from a pipeline upstream of a process, the method comprising:
separating liquid and gas of the flow from the pipeline upstream of the process;
outputting the gas from a gas outlet to the process;
outputting the liquid from a liquid outlet to the process;
moving at least one surface inside a portion of the liquid outlet; and
moving debris in the portion of the liquid outlet with the movement of the at least one surface relative to at least one outlet port in the liquid outlet.

20. A method of cleaning a slug catcher, the slug catcher catching slugs of flow from a pipeline upstream of a process, the slug catcher having an outlet manifold with at least one outlet port, the method comprising:
mounting at least one mover internal to a portion of the outlet manifold;
mounting at least one actuator adjacent the outlet manifold;
operatively coupling the at least one actuator to the at least one mover; and
moving debris in the portion of the liquid outlet manifold relative to the at least one outlet port by moving, with the at least one actuator, the at least one mover inside the portion of the outlet manifold.

21. The method of claim 20, wherein mounting the at least one mover internal to the portion of the outlet manifold comprises replacing the outlet manifold existing on the slug catcher with the outlet manifold having the at least one mover.

22. The method of claim 20, wherein mounting the at least one mover internal to the portion of the outlet manifold comprises accessing an interior of the outlet manifold existing on the slug catcher and installing the at least one mover therein.
